(19) United States
(12) Patent Application Publication
(10) Pub. No.: US 2007/0038832 A1
(43) Pub. Date: Feb. 15, 2007

(54) COMMUNICATION SYSTEM OF CASCADED DEVICES WITH A BACKUP FUNCTION AND ACTIVE/STANDBY SWITCHOVER METHOD THEREOF

(75) Inventor: Haijun Wu, Guangdong (CN)

Correspondence Address: HARNESS, DICKEY & PIERCE, P.L.C., P.O. BOX 828, BLOOMFIELD HILLS, MI, 48303, US

(73) Assignee: Huawei Technologies Co., Ltd., Shenzhen (CN)

(21) Appl. No.: 11/463,165

(22) Filed: Aug. 8, 2006

Related U.S. Application Data
(63) Continuation of application No. PCT/CN05/00232, filed on Feb. 25, 2005.

(30) Foreign Application Priority Data
Feb. 25, 2004 (CN) 200410007591.1

(51) Int. Cl. G06F 13/00

(52) U.S. Cl. 711/167

(57) ABSTRACT

A communication system of cascaded devices with a backup function includes a line adapter with multiple inputs and multiple outputs. Wherein, the communication devices of adjacent levels are cascaded through the line adapter, in each communication device, the port of an active main control board which is connected to the line adapter is open, and the port of a standby main control board is closed. The present invention also discloses two Active/Standby switchover methods applied in the above-mentioned communication system, by performing on-off control upon a communication device's interfaces connected to the line adapter, it is guaranteed that the communication devices cascaded by this communication device does not need to perform Active/Standby switchover in main control boards. By applying the present invention, the system's Active/Standby reliability and stability can be improved besides the implementing costs can be reduced.

### CROSS-REFERENCE TO RELATED APPLICATIONS

This application is a continuation of International Application No. PCT/CN2005/000232 filed on Feb. 25, 2005. This application claims the benefit of Chinese Patent Application No. 200410007591.1 filed on Feb. 25, 2004. The disclosures of the above applications are incorporated herein by reference.

### FIELD

The present disclosure relates to backup and Active/Standby switchover technology of communication devices, and more particularly, to a communication system of cascaded devices with a backup function and an Active/Standby switchover method thereof.

### BACKGROUND

The statements in this section merely provide background information related to the present disclosure and may not constitute prior art.

Device backup and Active/Standby switchover are necessary functions for a communication system to maintain long term reliable operations. At present, many communication systems adopt cascade structure, for instance: a Digital Subscriber Line (DSL) access system can be cascaded by a plurality of Digital Subscriber Line Access Multiplexers (DSLAMs), and in different DSL access systems, most DSLAMs have a backup function and Active/Standby switchover function, but some DSLAMs do not.

A DSLAM is a kind of frequently used device in a broadband access network and can be divided into two types in terms of the structure, which includes a frame DSLAM and a box DSLAM. The two kinds of DSLAMs both consist of three parts commonly: a main control board, user interface board, and backboard. The main control board provides a control function of the system, data stream process/distribution function, convergence function, uplink network side interface, and so on. The frame DSLAM access device usually has two main control boards to provide the Active/Standby switchover function. The user interface board provides an access interface for the user externally, and different user interface boards provide different access manners, such as Asynchronous Digital Subscriber Line (ADSL), Very high bit-rate Digital Subscriber Line (VDSL), Ethernet, G. Simple-pair High-speed Digital Subscriber Line (G. shdsl), etc. Generally, a DSLAM can provide more than one user interface board at the same time, a backboard can provide connections between the main control board and user interface board, wherein, the main control board and user interface board are both fixed at a slot of the backboard which usually provides a data bus for transmitting data between the main control board and user interface board.

The simplest cascade method of the DSL access system is two-level cascade. The box broadband access device is seldom applied at present, wherein a plurality of DSLAMs are cascaded through optical interfaces and each set of DSLAMs only supports one main control board, thus Active/Standby switchover function can not be provided. While the frame broadband access device is widely used, and especially, two application cases are provided as follows. One is that only the primary frame supports Active/Standby switchover, and the other is that both the primary and slave frames support Active/Standby switchover. The primary frame refers to a frame of which output interface is directly connected to the service network, and a slave frame refers to a frame that is connected to the service network through the primary frame. In other words, the primary frame and slave frame are cascaded. Situations of the two Active/Standby switchover methods will be respectively illustrated with reference to the two-level cascade.

As shown in FIG. 1, FIG. 1 is a schematic diagram illustrating device cascade in a system where only the primary frame supports Active/Standby switchover in the prior art (This Figure only shows main control boards of a primary frame and those of a slave frame, while other boards are not shown herein). Wherein the primary frame cascades two slave frames including frames 1 and 2. The primary frame contains main control boards 1 and 2 of the primary frame, which are a backup for each other, wherein the slave frame 1 includes a main control board of the slave frame 1, and the slave frame 2 includes a main control board of the slave frame 2.

The structures of the main control board 1 of the primary frame and main control board 2 of the primary frame are completely the same and both include: a control module, data process module, interface module, and Active/Standby detection module. Wherein, the control module is for accomplishing the whole system's software process and control, mainly including components like CPU and memory as well as software. The data process module is in charge of data forward and process, which is completed by hardware switching, forward logic, or chips. The interface module is for implementing external physical interfaces, such as interfaces of Fast Ethernet (FE), Gigabit Ethernet (GE), Asynchronous Transfer Mode (ATM), and so on, which can be either optical or electric interfaces. The Active/Standby detection module is used to detect the other main control board in real-time. The Active/Standby detection module detects the hardware state of the other main control board by detecting the on-site signal of the other main control board, and generates and sends the Active/Standby state signal of the local board to the control module of the local board according to the detection result. If an invalid on-site signal of the other main control board is detected, namely, this main control board is pulled out or breaks down, the Active/Standby state signal of the local board shall be set as an active state signal; otherwise, the Active/Standby state signal of the local board shall be set as a standby state signal. The control module performs Active/Standby switchover according to this Active/Standby state signal. Wherein, the Active/Standby state signal of the local board can also be set by the control module of the local board.

The structure of the main control board of the slave frame 1 is completely the same as that of the main control board of the slave frame 2. Because the slave frame has a main control board, both of the main control board of the slave frame 1 and the main control board of the slave frame 2 contain only: a control module, data process module, and interface module.

In FIG. 1, only the primary frame performs Active/Standby switchover, while the main control board of the slave frame provides two interfaces that are respectively connected to the two boards of active and standby main control boards of the primary frame. In this case, the slave frame does not have an Active/Standby switchover capability, which will lead to a severe drop in the reliability of the communication system.

With reference to FIG. 2, it is a schematic diagram illustrating device cascaded in a system where both the primary frame and slave frame support Active/Standby switchover in the prior art. (This figure only shows main control boards of the primary frame and slave frames, while other boards are not shown herein). Therein, the primary frame cascades two slave frames including slave frame 1 and slave frame 2. The primary frame includes a main control board 1 of the primary frame and a main control board 2 of the primary frame, which are a backup board for each other. The slave frame 1 contains a main control board 1 of the slave frame 1 and main control board 2 of the slave frame 1, and the slave frame 2 includes a main control board 1 of the slave frame 2 and main control board 2 of the slave frame 2.

In FIG. 2, structures of various main control boards are completely the same as that of the main control board of the primary frame in FIG. 1, which is not to be illustrated herein. Because both the main control boards of the primary frame and slave frame support Active/Standby switchover, and the two main control boards of the primary frame are respectively connected to the two main control boards of the slave frame, only gapping switchover can be implemented. Gapping switchover means that the Active/Standby switchover of any frame's main control board will lead to the Active/Standby switchover of all the frame's main control boards. In this scheme, the two main control boards of every frame are divided into two parts of a main part and standby part, so corresponding protocols have to be supported between the frames during the implementation of the switchover. In addition, the switchover of a frame's main control board leads to the switchover of all the systems', which makes stable time and service interrupt time of the whole cascade system too long.

### SUMMARY

The present invention provides a communication system of cascaded devices with a backup function, at least including communication devices of various levels, each communication device at least including an active main control board and a standby main control board, and having an Active/Standby switchover function, wherein this communication system further comprises a line adapter with multiple inputs and multiple outputs,

the active main control board of the communication device in each level being connected to the active main control board and standby main control board of an adjacent-level communication device through the line adapter, and the standby main control board of the communication device in each level being connected to the active main control board and standby main control board of an adjacent-level communication device through the line adapter; and

the port in the active main control board connected to the line adapter being open while the port in the standby main control board connected to the line adapter being closed.

An Active/Standby switchover method of a communication system of cascaded devices, wherein: Active/Standby switchover is finished inside a communication device, an active main control board and standby main control board of the communication device detects the hardware state of each other in real time, and the switchover procedure includes:

when detecting that the active main control board has been pulled out or broken down, the standby main control board promoting its local Active/Standby state as active; and

the standby main control board opening its port which connects the standby main control board to the line adapter according to the current Active/Standby state to switchover itself as an active main control board.

In the above solution, either the active main control board or the standby main control board may detect the hardware state of each other through its own Active/Standby detection module; the step of the standby main control board promoting its local Active/Standby state as active may include: the standby main control board setting its own Active/Standby state signal as active and sending this signal to the control module of the standby main control board; and the step of the standby main control board opening its port connected to the line adapter according to the current Active/Standby state to switchover itself as an active main control board may include: the control module of the standby main control board real-timely detecting its local Active/Standby state signal, and if this signal is active, opening the standby main control board's port connected to the line adapter to switchover the local board as an active main control board.

Moreover, the invention provides an Active/Standby switchover method of a communication system of cascaded devices, wherein, Active/Standby switchover is finished inside a communication device including an active main control board and standby main control board, and the switchover procedure includes:

the active main control board confirming that Active/Standby switchover is needed;

the active main control board notifying the standby main control board that Active/Standby switchover is needed; and setting its local Active/Standby state as standby;

according to the notification from the active main control board, the standby main control board setting its local Active/Standby state as active;

the active main control board closing its port connected to the line adapter to switchover itself as a standby main control board according to the current local Active/Standby state; and

the standby main control board opening its port connected to the line adapter to switchover itself as an active main control board according to the current local Active/Standby state.

In the above solution, the method of the active main control board setting its local Active/Standby state as standby may include: setting the Active/Standby state of the Active/Standby detection module in the active main control board as standby; the method of the standby main control board setting its local Active/Standby state as active may include: setting the Active/Standby state of the Active/Standby detection module in the standby main control board as active; the method of the active main control board closing its port connected to the line adapter according to the current local Active/Standby state may include: the control module of the active main control board detecting its local Active/Standby state signal real-timely, and closing the port connected to the line adapter if this signal is standby; and the method of the standby main control board opening its port connected to the line adapter according to the current local Active/Standby state may include: the control module of the standby main control board detecting its local Active/Standby state signal real-timely, and opening the port connected to the line adapter if this signal is active.

It can be seen from the above-illustrated technical scheme that, line adapters are added to the communication system in the present invention, and adjacent-level communication devices are cascaded through a line adapter. When a main control board of a communication device of a certain level is implementing Active/Standby switchover, by performing on-off control upon the interfaces of this communication device connected to the line adapter, it is guaranteed that the communication device of an adjacent-level of this communication device does not have to undertake Active/Standby switchover. In this way, the present invention implements that the active and standby main control boards of various levels can respectively undertake the switchover operation flexibly, so that the gapping switchover scheme is not needed anymore in realizing Active/Standby switchover among communication devices of different levels. And the present invention can also make sure that main control board in communication devices of each level can implement a backup function. The present invention may resolve the problem of Active/Standby switchover of cascaded devices in the system and greatly improve the reliability and stability of Active/Standby switchover in the system.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a schematic diagram illustrating device cascade in a system where only the primary frame supports Active/Standby switchover in the prior art;

FIG. 2 is a schematic diagram illustrating device cascade in a system where both the primary frame and slave frame support Active/Standby switchover in the prior art;

FIG. 3 is a schematic diagram illustrating device cascade in a system in an embodiment of the present invention;

FIG. 4 is a schematic diagram illustrating the structure and connection of another kind of optical line adapters in the embodiment shown in FIG. 3;

FIG. 5 is a schematic diagram illustrating the first position of an optical line adapter in a DSLAM in the embodiment shown in FIG. 3;

FIG. 6 is a schematic diagram illustrating the second position of an optical line adapter in a DSLAM in the embodiment shown in FIG. 3;

FIG. 7 is a schematic diagram illustrating optical paths when a main control board in a primary frame is normal in the embodiment shown in FIG. 3;

FIG. 8 is a flowchart illustrating the first Active/Standby switchover method of a main control board in the embodiment shown in FIG. 3;

FIG. 9 is a flowchart illustrating the second Active/Standby switchover method of a main control board in the embodiment shown in FIG. 3;

FIG. 10 is a schematic diagram illustrating optical paths after the Active/Standby switchover of a main control board in a primary frame in the embodiment shown in FIG. 3.

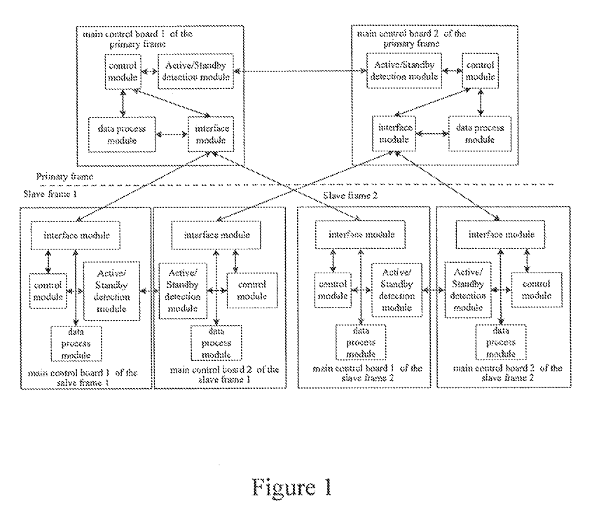

### DETAILED DESCRIPTION

The following description is merely exemplary in nature and is not intended to limit the present disclosure, application, or uses. It should be understood that throughout the drawings, corresponding reference numerals indicate like or corresponding parts and features.

The present invention will be described in detail hereinafter with reference to the accompanying drawings.

The key idea of the communication system of cascaded devices with a backup function and the Active/Standby switchover method thereof in accordance with the present invention includes: adding line adapters in the communication system by which adjacent-level communication devices are cascaded, and when a main control board of a certain level communication device is performing Active/Standby switchover, by performing on-off control upon interfaces connected to the line adapters of this communication device, it is guaranteed that the adjacent-level communication devices of this communication device need not perform the Active/Standby switchover of a main control board.

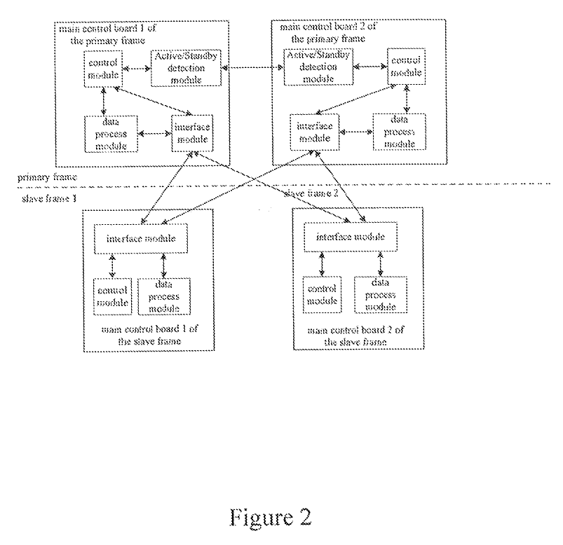

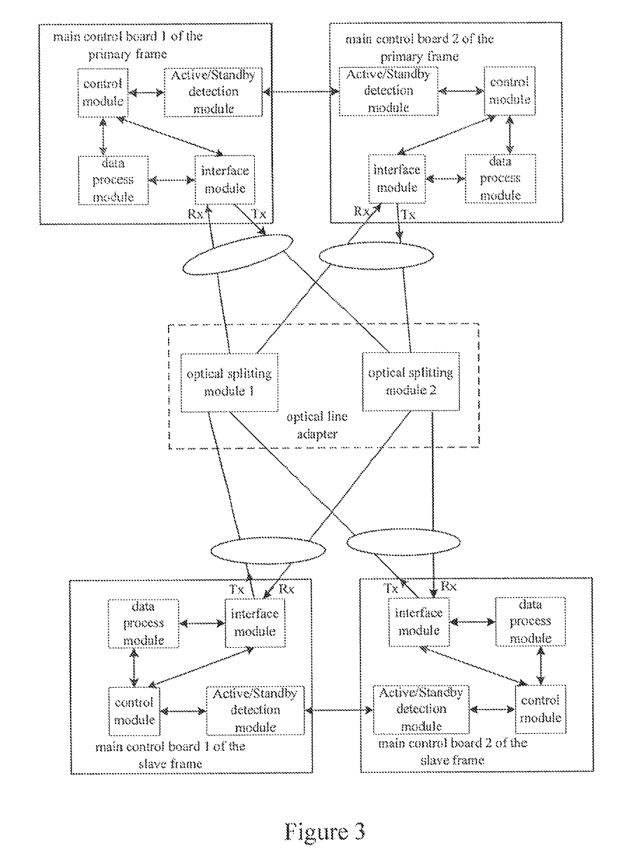

With reference to FIG. 3, it is a schematic diagram illustrating device cascade in a system of an embodiment of the present invention. This embodiment refers to a broadband access system constituted by DSLAMs cascaded through optical fibers. FIG. 3 shows how the two DSLAMs of a primary frame and those of a slave frame are cascaded through an optical line adapter. Therein, the primary frame includes a main control board 1 of the primary frame and a main control board 2 of the primary frame, and the slave frame includes a main control board 1 of the slave frame and a main control board 2 of the slave frame. The structure and connection of the two main control boards of the primary fame and that of the two main control boards of the slave frame are the same as that shown in FIG. 2, which are not to be illustrated repeatedly herein.

Cascade manners of the two frames will be illustrated hereinafter:

The DSLAM of the primary frame and that of the slave frame in this embodiment are cascaded by an optical line adapter. An optical interface of an interface module includes a receiving optical fiber, RX, and a transmitting optical fiber, TX. So the optical line adapter in the embodiment consists of two independent 2-input/2-output modules which are an optical splitting module 1 and optical splitting module 2.

An optical splitting module is a kind of passive optical parts frequently used, for completing optical signal synthesis and distribution, of which working principle is: by synthesizing multiple inputs of optical signals into one optical signal according to a configured ratio and distributing this optical signal to multiple outputs according to the configured ratio. The two parts of functions can be either implemented separately or implemented in one module, i.e., the optical splitting module may be a many-to-one module or many-to-many module. Optical splitters can be classified according to different optical splitting ratios, the wavelength of the optical fiber interface, and the number of input/output ports.

The optical splitting ratio of both the optical splitting module 1 and optical splitting module 2 in the present embodiment is 50/50, and the number of input/output ports of both the optical splitting module 1 and optical splitting module 2 are 2 input ports and 2 output ports. Signals from the two input optical interfaces of this kind of optical splitting module are synthesized into one optical signal which is then split into two signals, each of which is 50% of the synthesized signal, and the two signals are output through the two output ports respectively. The wavelength of the optical fiber interface should be selected according to different types of optical interfaces, like a wavelength of 1310 nm etc.

As shown in FIG. 3, the two output ports of the optical splitting module 1 are respectively connected to the interface module's RX of the main control board 1 and that of the main control board 2, wherein the main control boards 1 and 2 are both a main control board of the primary frame; the two input ports of the optical splitting module 1 are respectively connected to the interface module's TX of the main control board 1 and that of the main control board 2, wherein the main control boards 1 and 2 are both a main control board of the slave frame; the two input ports of the optical splitting module 2 are respectively connected to the interface module's TX of the main control board 1 and that of the main control board 2, wherein the main control boards 1 and 2 are both a main control board of the primary frame; and the two output ports of the optical splitting module 2 are respectively connected to the interface module's RX of the main control board 1 and that of the main control board 2, wherein the main control boards 1 and 2 are both a main control board of the slave frame. That is to say, the main control boards 1 and 2 of the slave frame transmit information through the optical splitting module 1, and the main control boards 1 and 2 of the primary frame receive information through the optical splitting module 2.

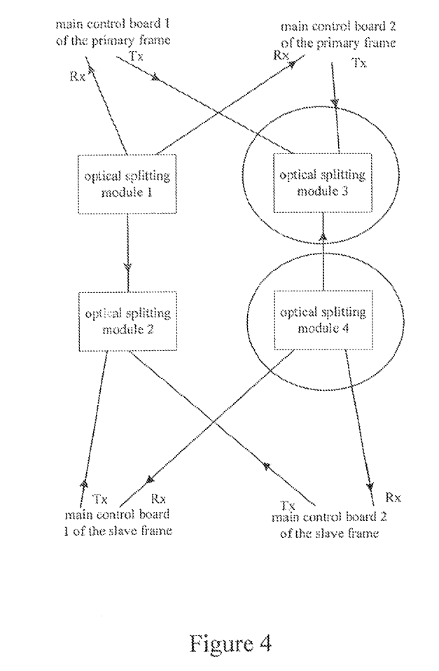

Besides, the optical line adapter of the present invention can also be implemented by two 2-input/1-output optical splitting modules and two 1-input/2-output optical splitting modules, of which the structure is shown in FIG. 4. FIG. 4 is a schematic diagram illustrating the structure and connection of another kind of optical line adapters in the embodiment shown in FIG. 3. This optical line adapter is implemented by combing two 1-input/2-output modules including the optical splitting modules 1 and 4 as well as two 2-input/1-output modules including the optical splitting modules 2 and 3. Therein, the two outputs of the optical splitting module 1 are respectively connected to the interface modules' RXes of the primary frame's main control boards 1 and 2, and the output of the optical splitting module 1 is connected to the output of the optical splitting module 2; and the two inputs of the optical splitting module 2 are respectively connected to the interface modules' TXes of the slave frame's main control boards 1 and 2. The two inputs of the optical splitting module 3 are respectively connected to the interface modules' TXes of the primary frame's main control boards 1 and 2, and the output of the optical splitting module 3 is connected to the input of the optical splitting module 4; and the two inputs of the optical splitting module 4 are respectively connected to the interface modules' RXes of the slave frame's main control boards 1 and 2.

In practical application, if there are too many cascaded devices of slave frames, the solution in accordance with the invention can be implemented by selecting multiple-input/multiple-output optical splitting modules according to the total number of the main control boards and that of the optical interfaces in each slave frame, or by combining the multiple-input/multiple-output optical splitting modules or/and multiple-input/single-output optical splitting modules together. It must be ensured that the input/output port number of the line adapter are no less than the port number of the interface modules in the primary and standby main control boards of two adjacent levels, in other words, it must be guaranteed that each of the primary and standby main control boards in an level can be connected to any of the primary and standby main control boards in its lower level.

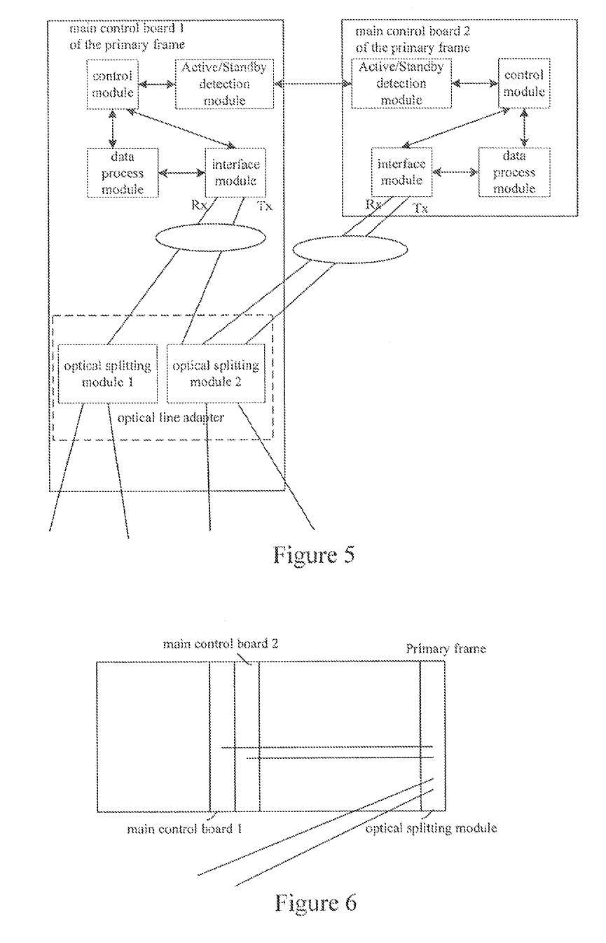

The optical line adapter in the present embodiment can be set as an independent device, or be integrated in a certain main control board, or be located inside a DSLAM frame as an independent single board. When the optical line adapter is integrated in a certain main control board, as shown in FIG. 5, the optical line adapter may be selected to be integrated in an active main control board or in a standby main control board; and when the optical line adapter is located inside a DSLAM frame, as shown in FIG. 6, the optical line adapter may be selected to be located inside a primary DSLAM frame.

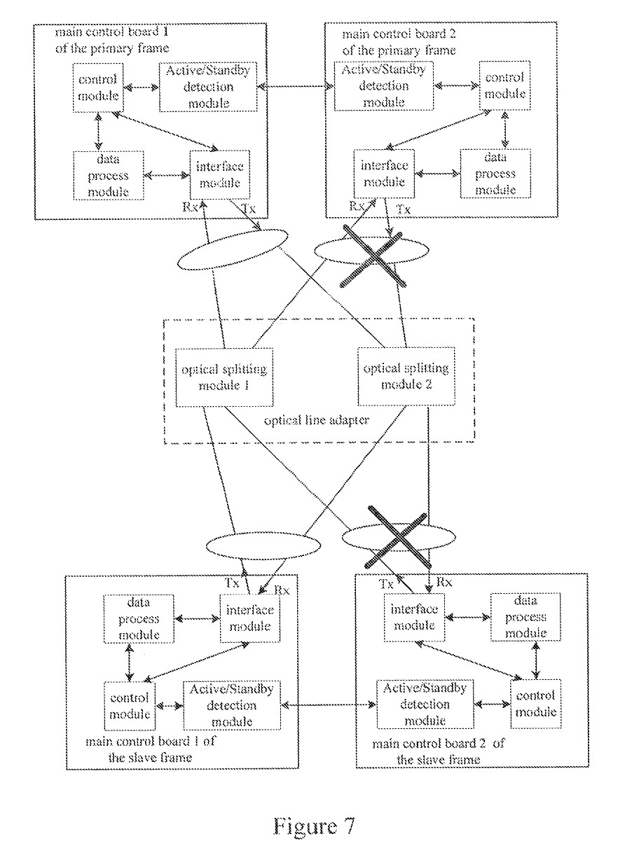

Suppose that, in FIG. 3, in the primary frame, the main control board 1 is an active main control board, the main control board 2 is a standby main control board, and the interface module's optical interface in the main control board 1 is open while that of the main control board 2 is closed; and in the slave frame the main control board 1 is an active main control board, the main control board 2 is a standby main control board, and the interface module's optical interface in the main control board 1 is open while that of the main control board 2 is closed. Based on the above conditions, the optical path when the primary frame's main control boards are normally operating is shown in FIG. 7 which is a schematic diagram illustrating the optical path when the main control boards in the primary frame is in normal operation in the embodiment shown in FIG. 3. The optical splitting module 1 connects the interface module's RX of the primary frame's main control board 1 to the interface module's TX of the slave frame's main control board 1; and the optical splitting module 2 connects the interface module's TX of the primary frame's main control board 1 to the interface module's RX of the slave frame's main control board 1. In this way, optical signals are transmitted between the primary frame's main control board 1 and the slave frame's main control board 1. Because the optical interface of interface module has been closed, there is no optical signal transmitted between the primary frame's main control board 2 and the slave frame's main control board 2.

There are two ways to implement the Active/Standby switchover of the main control board in the present embodiment: the first way is to implement Active/Standby switchover through detecting the active main control board by the standby main control board. The second way is that the active main control board notifies the standby main control board to perform the Active/Standby switchover. The two ways are respectively illustrated as follows:

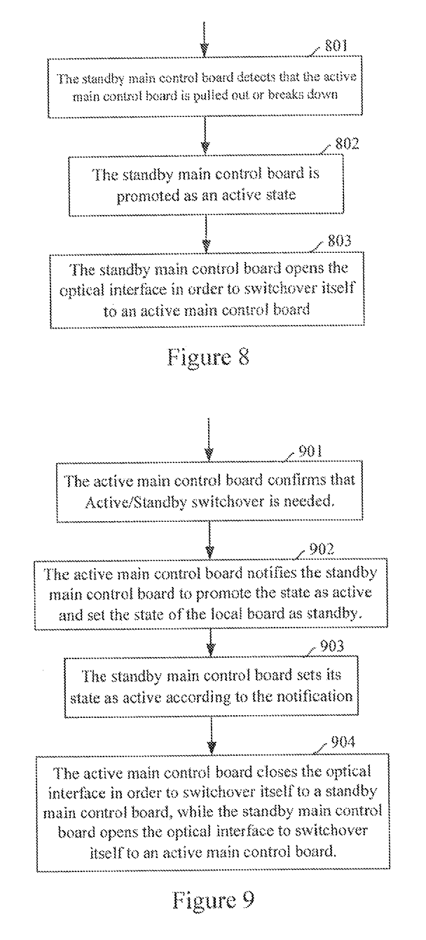

The first Active/Standby switchover method includes: completing Active/Standby switchover inside each communication device, and the active main control board and standby main control board of each communication device detecting the hardware state of each other in real time, wherein the switchover procedure is as shown in FIG. 8. FIG. 8 is a flowchart illustrating the first Active/Standby switchover method of main control boards in the embodiment shown in FIG. 3. This procedure includes the following steps:

Step 801: The standby main control board detects that the active main control board has been pulled out or broken down.

This step is implemented by detecting the on-site signals by an Active/Standby detection module of the active main control board and that of the standby main control board. The Active/Standby detection module is used to detect the state of the other main control board real-timely. The Active/Standby detection module detects the hardware state of the other main control board by detecting the on-site signal thereof, generates an Active/Standby state signal of the local board based on the detecting result, and sends this signal to the control module of the local board. If an invalid on-site signal of the other main control board has been detected, i.e., this main control board has been pulled out or broken down, the Active/Standby state signal of the local board will be promoted as an active state signal; otherwise, the Active/Standby state signal of the local board is set in a standby state. The control module will perform Active/Standby switchover according to this Active/Standby state signal of the local board.

This step is the same as it in the prior art, so detailed descriptions are not given here.

Step 802: The control module of the standby main control board detects its Active/Standby state signal real-timely. If the Active/Standby state signal comes to be active, i.e., the on-site signal of the active main control board is detected as invalid, or in other words, the active main control board is pulled out or breaks down, the active main control board resets its hardware state change, and the standby main control board promotes its state as active and notifies a software system.

Step 803: The standby main control board opens the optical interface by which its interface module is connected to the optical line adapter to switchover itself as an active main control board. By performing this step, the main control board in an active state is connected to the active main control board in the adjacent DSLAM.

The second Active/Standby switchover method includes: the Active/Standby switchover being finished inside each communication device wherein the switchover procedure is as shown in FIG. 9. FIG. 9 is a flowchart illustrating the second Active/Standby switchover method of the main control board in the embodiment shown in FIG. 3. This procedure includes the following steps:

Step 901: The active main control board confirms that Active/Standby switchover is needed. For instance, in the case of maintenance or software update or etc, the active main control board may determine to implement Active/Standby switchover according to user input.

Step 902: The active main control board notifies the standby main control board that Active/Standby switchover is needed, and meanwhile, sets the Active/Standby state single of the Active/Standby detection module of the local board as standby.

In this step, the control module of the active main control board can notify the control module of the standby main control board through a backboard bus that Active/Standby switchover is needed.

Step 903: The standby main control board sets its state as active according to the notification from the active main control board.

Step 904: The control module of the active main control board detects the Active/Standby state signal of the local board, and when detecting the signal as standby, closes the optical interface by which the active main control board is connected to the optical line adapter, in order to switchover this active main control board to a standby main control board.

On the other hand, the control module of the standby main control board detects the Active/Standby state signal of the local board, and opens the optical interface by which the standby main control board is connected to the optical line adapter when detecting the signal as active, in order to switchover this board to active main control board.

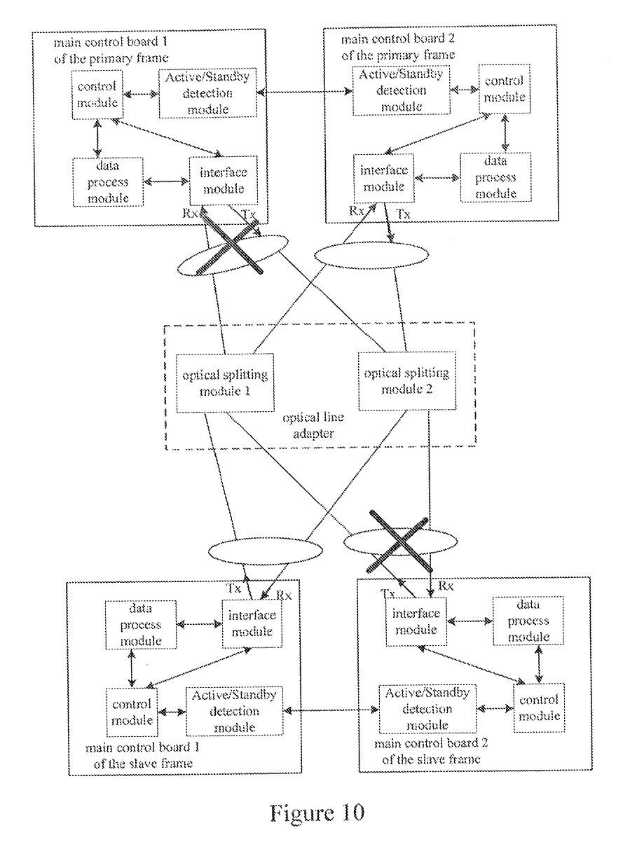

Suppose that the primary frame's main control board 1 breaks down. The Active/Standby switchover is performed by adopting one of the two methods mentioned above, and the optical paths after the switchover is as shown in FIG. 10. FIG. 10 is a schematic diagram illustrating the optical paths after performing the Active/Standby switchover upon the main control board of the primary frame in the embodiment shown in FIG. 3. After the switchover, in the primary frame, the main control board 2 is an active main control board while the main control board 1 is a standby main control board, and the optical interface of the interface module in the main control board 2 is open while the optical interface of the interface module in the main control board 1 is closed. The optical splitting module 1 connects the interface module's RX of the primary frame's main control board 2 with the interface module's TX of the slave frame's main control board 1, and the optical splitting module 2 connects the interface module's TX of the primary frame's main control board 2 with the interface module's RX of the slave frame's main control board 1. In this way, optical signals can be transmitted between the primary frame's main control board 2 and the slave frame's main control board 1. Because the interface module's optical interface of the primary frame's main control board 1 and that of the slave frame's main control board 2 are closed, there is no optical signal transmitted between the primary frame's main control board 1 and the slave frame's main control board 2.

To sum up, for the present embodiment, when the primary frame is performing Active/Standby switchover, the slave frame does not have to perform Active/Standby switchover, so that the system is of higher reliability and stability. In addition, optical splitting parts are adopted in the present embodiment to connect the Active/Standby main control boards of the DSLAMs in various levels, so that besides the system is of higher reliability, the implementing costs of the present invention can be reduced.

The present invention is not only confined to the above-mentioned embodiments, but also applicable for any communication system of cascaded devices, wherein if there are optical interfaces, the optical part in the above-mentioned embodiments can be used as the optical interfaces and if there are electric interfaces, any other part with similar function as the optical parts in the above-mentioned embodiments can be adopted.

What is claimed is:

1. A communication system of cascaded devices with a backup function, at least comprising communication devices of various levels, each communication device at least comprising an active main control board and a standby main control board, and having an Active/Standby switchover function, wherein this communication system further comprises a line adapter with multiple inputs and multiple outputs,
the active main control board of the communication device in each level being connected to the active main control board and standby main control board of an adjacent-level communication device through the line adapter, and the standby main control board of the communication device in each level being connected to the active main control board and standby main control board of an adjacent-level communication device through the line adapter; and
the port in the active main control board connected to the line adapter being open while the port in the standby main control board connected to the line adapter being closed.

2. The communication system according to claim 1, wherein the line adapter is an optical line adapter or electric line adapter.

3. The communication system according to claim 2, wherein, if the communication system is a Digital Subscriber Line (DSL) access system, the communication device is a Digital Subscriber Line Access Multiplexer (DSLAM), and the line adapter is an optical line adapter.

4. The communication system according to claim 3, wherein, the optical line adapter is an independent device or an independent single board set in the DSLAM, or the optical line adapter is set in an active main control board or standby main control board of the DSLAM.

5. The communication system according to claim 3, wherein, either the active main control board or the standby main control board is connected to the optical line adapter through the port of its own interface module.

6. The communication system according to claim 5, wherein, the input/output port number of the optical line adapter is no less than the port number of the interface modules in the active main control board and standby main control board of two adjacent levels.

7. The communication system according to claim 5, wherein, the optical line adapter comprises at least one independent optical splitting module with multiple inputs and multiple outputs; and
the optical line adapter is constituted by at least one optical splitting module with multiple inputs and single output, and/or optical splitting modules with multiple inputs and multiple outputs.

8. An Active/Standby switchover method of a communication system of cascaded devices, wherein: Active/Standby switchover is finished inside a communication device, an active main control board and a standby main control board of the communication device detects the hardware state of each other in real time, and the switchover procedure comprises:
when detecting that the active main control board has been pulled out or broken down, the standby main control board promoting its local Active/Standby state as active;
the standby main control board opening its port which connects the standby main control board to the line adapter according to the current Active/Standby state to switchover itself as an active main control board.

9. The method according to claim 8, wherein, either the active main control board or the standby main control board detects the hardware state of each other through its own Active/Standby detection module;
the step of the standby main control board promoting its local Active/Standby state as active comprises: the standby main control board setting its own Active/Standby state signal as active and sending this signal to the control module of the standby main control board; and
the step of the standby main control board opening its port connected to the line adapter according to the current Active/Standby state to switchover itself as an active main control board comprises: the control module of the standby main control board real-timely detecting its local Active/Standby state signal, and if this signal is active, opening the standby main control board's port connected to the line adapter to switchover the local board as an active main control board.

10. The method according to claim 8, wherein, if the communication system is a DSL access system, the communication device is a DSLAM; and the line adapter is an optical line adapter, and the port connected to the line adapter is an optical interface.

11. An Active/Standby switchover method of a communication system of cascaded devices, wherein, Active/Standby switchover is finished inside a communication device including an active main control board and a standby main control board, and the switchover procedure comprises:
the active main control board confirming that Active/Standby switchover is needed;
the active main control board notifying the standby main control board that Active/Standby switchover is needed; and setting its local Active/Standby state as standby;
according to the notification from the active main control board, the standby main control board setting its local Active/Standby state as active;
the active main control board closing its port connected to the line adapter to switchover itself as a standby main control board according to the current local Active/Standby state; and
the standby main control board opening its port connected to the line adapter to switchover itself as an active main control board according to the current local Active/Standby state.

12. The method according to claim 11, wherein, the method of the active main control board setting its local Active/Standby state as standby comprises: setting the Active/Standby state of the Active/Standby detection module in the active main control board as standby;
the method of the standby main control board setting its local Active/Standby state as active comprises: setting the Active/Standby state of the Active/Standby detection module in the standby main control board as active;
the method of the active main control board closing its port connected to the line adapter according to the current local Active/Standby state comprises: the control module of the active main control board detecting its local Active/Standby state signal real-timely, and closing the port connected to the line adapter if this signal is standby; and
the method of the standby main control board opening its port connected to the line adapter according to the current local Active/Standby state comprises: the control module of the standby main control board detecting its local Active/Standby state signal real-timely, and opening the port connected to the line adapter if this signal is active.

13. The method according to claim 11, wherein, if the communication system is a DSL access system, the communication device is a DSLAM, the line adapter is an optical line adapter, and the port connected to the line adapter is an optical interface.
